(19) United States
(12) Patent Application Publication
(10) Pub. No.: US 2005/0091865 A1
(43) Pub. Date: May 5, 2005

(54) Reusable vacuum pressing bag employing surface-tension properties of the bag material as a reusable seal for repetitive high pressure applications

(76) Inventor: Nicholas Gannon Yeager, Penngrove, CA (US)

Correspondence Address: Nicholas G. Yeager;Artifex Equipment, Inc., 9595 Main St., P.O. Box 319, Penngrove, CA, 94951-0319, US

(21) Appl. No.: 10/699,436

(22) Filed: Oct. 30, 2003

(51) Int. Cl. F26B 13/30

(52) U.S. Cl. 34/92

(57) ABSTRACT

Method for using surface-tension properties of polished vinyl or other plastic sheeting as a reusable seal on a vacuum pressing bag. The bag must be of a high surface tension material such as polished vinyl to create the friction to create a seal. The vinyl bag consists of at least two pieces of vinyl welded at the edge on all sides. A slit through one piece of vinyl allows entry into the bag. Another vinyl strip that is wider and longer than the slit is placed over the opening. The polished surface of the vinyl or other polymer creates surface tension that “self-seals” under mild hand pressure creating a complete seal after suction is supplied to achieve evacuation. This surface tension is not released until the vinyl flap is pulled away from the slit. Because the “seal” is created using a physical property of the bag material, it will never wear out. If the seal is complete, constant pressure on the contents of the bag is maintained while evacuation proceeds. A conventional vacuum pump produces the vacuum. To ensure long-term vacuum pressure, a permanently affixed quick-disconnect one-way valve is employed allowing the bag to be removed from the pump and set aside. This flexibility allows the bags to be stored out of the way, returning the work area to other pursuits. In addition, the item can be pressed for long periods without the necessity for additional suction to the bag system. This invention is designed to aid in lamination of three-dimensional objects such as books, veneer and art objects as well as drying wet objects where moisture must be drawn off quickly with the aid of pressure.

### CROSS REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

Industrial fabricators have used vacuum pressure bags for more than thirty years with great success in pressing three dimensional objects. Two kinds of pressure membranes have traditionally been used. A tent or membrane system with a fixed, rigid frame has been used to hold a vacuum, with the rigid frame acting as the sealing barrier. The second kind uses an envelope type of bag with a closure mechanism at the open end.

Industrial vacuum pressure bags based on an envelope design accept the part to be pressed through the opening. To dose the bag, it is folded over and sealed with a rod and channel system. Air leaks into the bag within minutes, requiring a renewal of the vacuum, thus necessitating the bag be kept permanently affixed to the vacuum pump. The closure mechanism using two pieces is cumbersome and porous.

There are numerous vacuum bags on the market for storing clothing that use one-way valves or a vacuum cleaner to create a compressed storage system, but none of these are designed for creating a substantial internal pressure to hold parts together within the bag. Made of lightweight material, their reuse is limited to a small number of times. None of these has been designed nor easily adaptable to an industrial use over many years with pressing capacity in excess of 10 psi.

### BACKGROUND—PRIOR ART

Flexible plastic bags which are capable of being evacuated and reused are known in the prior art by U.S. Pat. No. 5,240,112 to Newburger and U.S. Pat. No. 5,480,030 to Sweeney, et al. However none of them provide for a reusable seal that makes use of an inherent property of the bag's material: Surface tension. Each system provides for a more complex system of closure and evacuation valve than the present invention. By employing an otherwise annoying feature of polished vinyl or other polymers with a high surface tension, the opening through which the work is placed in the bag becomes the leading edge of the seal. With very little manual manipulation in the form of pressing all along the leading edge of the bag, a seal is formed by the friction of the bag itself. By adding an exit valve fitted with a quick-disconnect one-way valve, the bag can be loaded with the work to be pressed, evacuated and detached from the vacuum source. Because of its lightweight, bag and contents can be moved to storage elsewhere while pressing over time occurs. By incorporating commercially available hardware materials and established radio-frequency welding, bags can be made inexpensively to provide for purchase of a number of bags per user. These then can be cycled through the work flow, so that no bottleneck occurs at the pressing stage of manufacture or drying; a long-standing impedance to drying books, paper and pressing laminates such as veneer work.

### FIELD OF THE INVENTION

The present invention relates to using a vacuum bag chamber as a pressing device for pressing items such as books, veneer, compacting waste materials, drying wet objects as in papermaking, and water-damage recovery of books, and laminating multiple substrates requiring a high, constant and even pressure to complete the work.

### SUMMARY OF THE INVENTION

The general purpose of the present invention is to make a vacuum pressing bag that can be reused thousands of times; is detachable from the pump, and strong enough for industrial use. Bookbinding, manufacturing artistic, military, medical uses for air-tight or pressed storage of materials and wastes will benefit from applying this invention to their specific needs. An integral feature of the invention is the elimination of all extraneous parts from the seal by taking advantage of surface tension inherent in polished vinyl. The seal will not wear out as long as the vinyl stays polished and smooth.

The present invention is achieves several advantages to aid in pressing three dimensional objects such as books, paper, wood veneer, plants, contaminated waste materials and other objects requiring compression. These advantages include:
1) a portable and inexpensive vacuum pressing device for use at various locations
2) reusable yet strong vacuum pressing bags with an integrated sealing mechanism
3) removal of the bag from the vacuum pump using a one-way quick-disconnect valve.
4) and ease of air evacuation to achieve vacuum pressure by use of an air drain.

### BRIEF DESCRIPTION OF THE DRAWINGS

FIG. 1 is a plan view of a flexible plastic bag sealed on all four sides, provided with a slit for entry and the critical point for surface tension sealing, a flap to raise the bag and assist in sealing and an exit valve;

FIG. 2 is an exploded view of the bag showing the position of the, slit, flap and valve stem;

FIG. 3 is an cross section of the seal as it forms at the slit entrance to the bag;

FIG. 4 is an enlarged view of the valve stem with a conventional one-way quick-disconnect valve inserted.

### DETAILED DESCRIPTION OF THE DRAWINGS

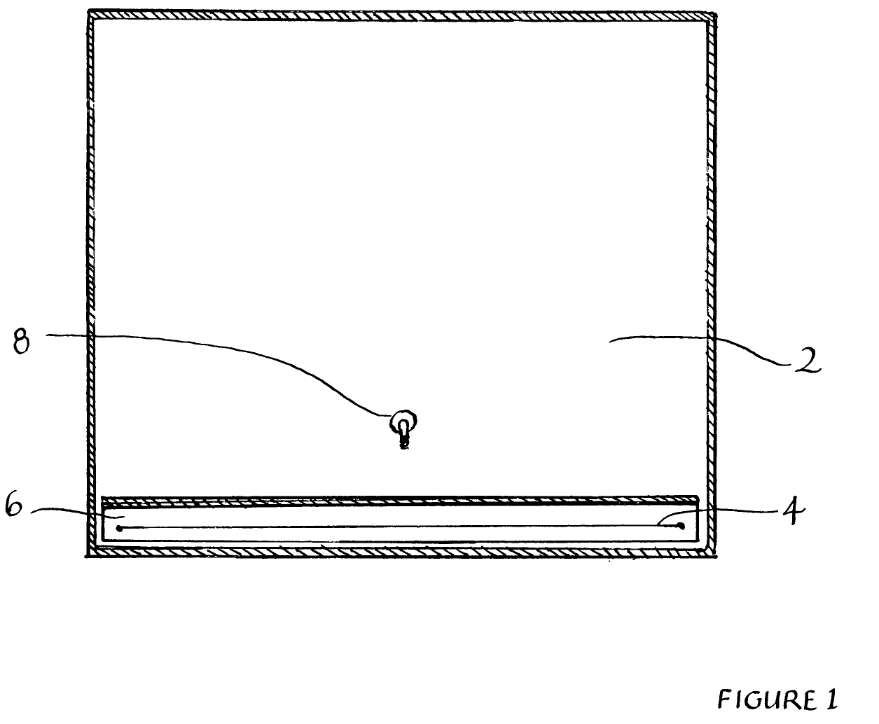

FIG. 1 shows a flexible plastic bag 2 in accordance with the present invention. The bag 2 is shown with all four sides sealed with conventional RF welding technique and includes an entry slit 4 that is the critical point for surface tension sealing, a flap for opening the bag 6, and an exit valve 8, that allows air to be removed from the bag using a conventional vacuum pump.

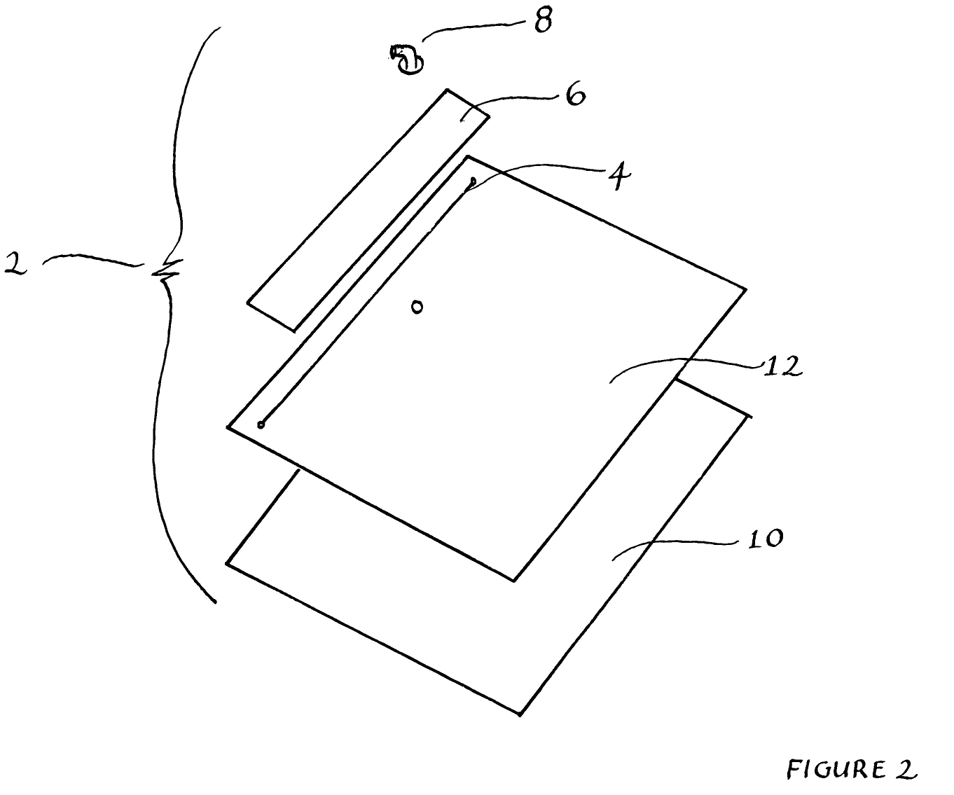

FIG. 2 shows an exploded view of the bag 2 showing the base sheet of bag material 10, the upper sheet 12, with slit 4, flap 6, and exit valve 8.

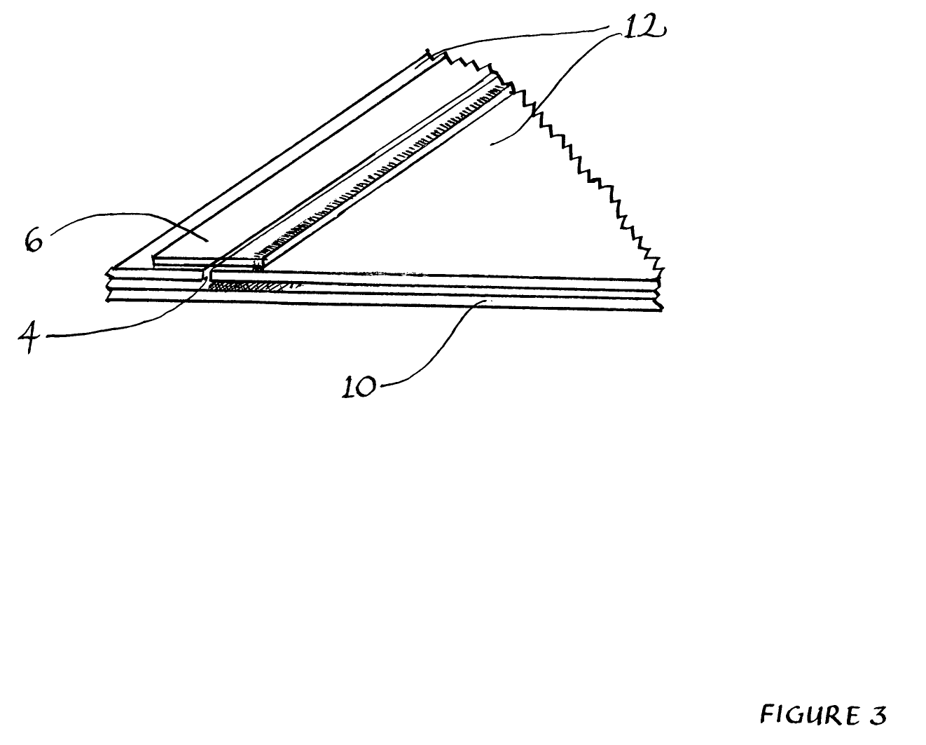

FIG. 3 shows a cross section of the surface tension seal that is created when the sheet 12 is pressed with fingers or palm down onto the lower sheet 10. Surface tension created as pressure is applied for the length of the slit 4 thereby creating an airtight seal that will hold for months without leaking. To enter the bag 2, pulling upward on the flap 6, breaks the seal for that pressing. The seal will not wear out because high surface tension is an inherent property of the bag 2 material.

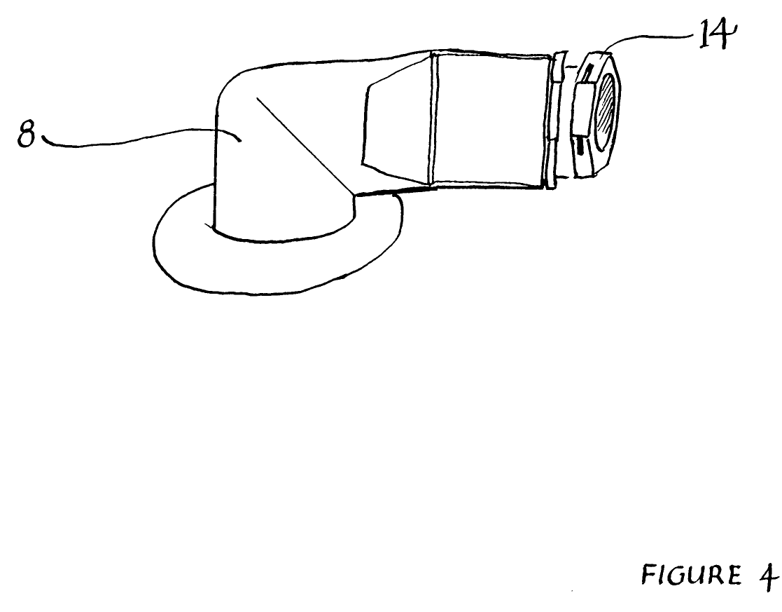

FIG. 4 shows the exit valve 8, that is welded into the bag with the quick-disconnect one-way valve 14 inserted into its opening. The exit valve is designed as a port and may be used with other fittings.

1. Method for using surface-tension properties of polished vinyl and other plastic sheeting as a reusable seal on a vacuum pressing bag. Taking advantage of the material's surface tension, the seal is created when the vinyl is pressed into contact with the corresponding material. Hand pressure will flatten the two sheets together where surface tension will create the seal that converts the bag into a vacuum chamber. The flap over the slit protects the seal and is used as a handle to open the bag.

2. A process for using a vacuum bag chamber as a press for drying items contained within by applying pressure of 20 in/Hg and greater. The bag is welded on all four edges with a slit in the upper panel and a flap overlapping the slit. The item or work is placed inside the bag through the slit and placed away from the slit so that the upper and lower parts of the bag will come into intimate contact with each other at the leading edge of the slit.

3. Attaching a one-way quick-disconnect valve to the bag allows the bag to be evacuated and detached from the vacuum pump. This frees the work space for other uses as well as multiplying the available pressing devices with low-cost vacuum bags. Because the bags continue to hold contents under pressure until the pressing cycle is complete, production bottlenecks at this point are diminished.
